(19) United States
(12) Patent Application Publication
(10) Pub. No.: US 2013/0294854 A1
(43) Pub. Date: Nov. 7, 2013

(54) CUTTING TOOL ASSEMBLY

(71) Applicant: TAEGUTEC, LTD., Daegu (KR)

(72) Inventor: Chul Ho LEE, Daegu (KR)

(73) Assignee: TaeguTec, Ltd., Daegu (KR)

(21) Appl. No.: 13/868,625

(22) Filed: Apr. 23, 2013

(30) Foreign Application Priority Data
May 2, 2012 (KR) 10-2012-0046412
Apr. 9, 2013 (KR) 10-2013-0038820

(51) Int. Cl. B23B 27/16

(52) U.S. Cl. CPC B23B 27/16
USPC 407/101

(57) ABSTRACT

A cutting tool assembly has a cutting insert, an insert holder and a tool shank. The insert holder has an insert receiving slot, a plurality of through holes and first and second recesses. Clamping screws pass through the through holes. The first and second recesses are located at an edge of a rear surface of the insert holder and are opposed to each other relative to an orientation of the slot. The tool shank has a plurality of threaded holes and first and second flanges. The clamping screws engage the threaded holes. The first and second flanges are opposed to each other and engage the first and second recesses, respectively. The insert holder is removably mounted to the tool shank by the clamping screws. The through holes are offset from the threaded holes when the insert holder is mounted to the tool shank.

### CROSS-REFERENCE TO RELATED APPLICATIONS

This application claims priority from Korean Patent Application No. 10-2012-0046412 filed on May 2, 2012 and Korean Patent Application No. 10-2013-0038820 filed on Apr. 9, 2013, the entire subject matters of which are incorporated herein by reference.

### TECHNICAL FIELD

The present disclosure relates to a cutting tool assembly including a tool shank and an insert holder removably secured to the tool shank.

### BACKGROUND

FIG. 1 shows a parting tool disclosed in U.S. Pat. No. 4,938,641. Referring to FIG. 1, the parting tool includes a tool shank 1 and a blade support 2. The tool shank 1 has two opposing flanges 4 and 5. One of the flanges 4 has a guide surface 6 and a contact surface 8. The other flange 5 also has a guide surface 7 and a contact surface 9. The blade support 2 has two segments 10 and 11 facing the guide surfaces 6 and 7, respectively, and two counter surfaces 12 and 13 contacting the contact surfaces 8 and 9 respectively. The blade support 2 is secured to the tool shank 1 by screws 14, 15 and 16.

A principal cutting force may be applied to the parting tool in the direction of an arrow shown in FIG. 1 during a cutting operation. A stress concentrating on the contact surface 9 may damage or deform the flange 5 and space the contact surface 8 and the counter surface 12 apart from each other. Further, a stress concentrating on the guide surface 6 may damage or deform the flange 4. Thus, the conventional parting tool has a weak clamping force between the tool shank 1 and the blade support 2.

### SUMMARY

The present disclosure provides embodiments of a cutting tool assembly that is capable of intensifying the engagement between an insert holder and a tool shank and intensifying the clamping between an insert holder and a cutting insert.

In one exemplary embodiment, by way of a non-limiting example, a cutting tool assembly includes a cutting insert, an insert holder, a tool shank and a plurality of clamping screws. The insert holder includes a slot, a plurality of through holes and first and second recesses. The slot extends radially outward and receives the cutting insert. The clamping screws pass through the through holes. The first and second recesses are located at an edge of a rear surface of the insert holder and are opposed to each other relative to an orientation of the slot. The tool shank includes a plurality of threaded holes and first and second flanges. The clamping screws engage the threaded holes. The first and second flanges are opposed to each other and engage the first and second recesses, respectively. The insert holder is removably mounted to the tool shank by the clamping screws. The through holes of the insert holder are offset from the threaded holes of the tool shank when the insert holder is mounted to the tool shank.

This Summary is provided to introduce a selection of concepts in a simplified form that are further described below in the detailed description. This Summary is not intended to identify key or essential features of the claimed subject matter, nor is it intended to be used in determining the scope of the claimed subject matter.

### BRIEF DESCRIPTION OF THE DRAWINGS

FIG. 1 is an exploded perspective view showing a prior art parting tool.

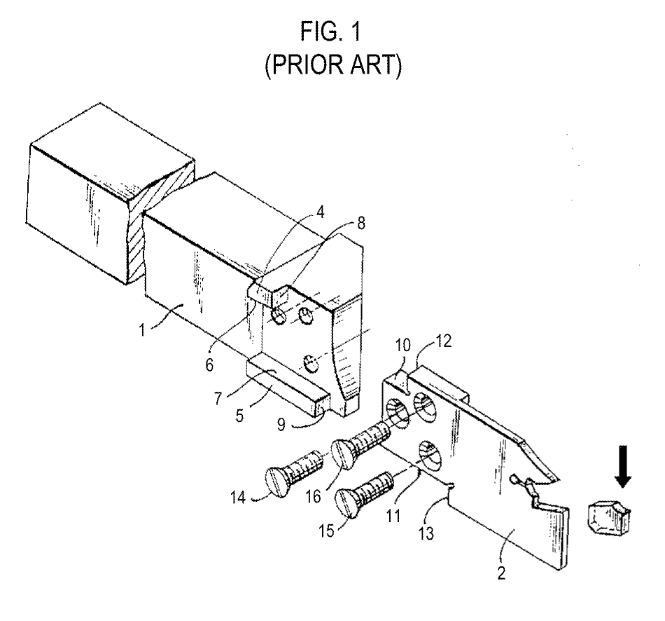

FIG. 2 is a perspective view showing a cutting tool assembly according to an embodiment.

FIG. 3 is an exploded perspective view of the cutting tool assembly shown in FIG. 2.

FIG. 4 is a front view of an insert holder shown in FIG. 2.

FIG. 5 is a rear view of the insert holder shown in FIG. 2.

FIG. 6 is a perspective view showing a front end portion of a tool shank shown in FIG. 2.

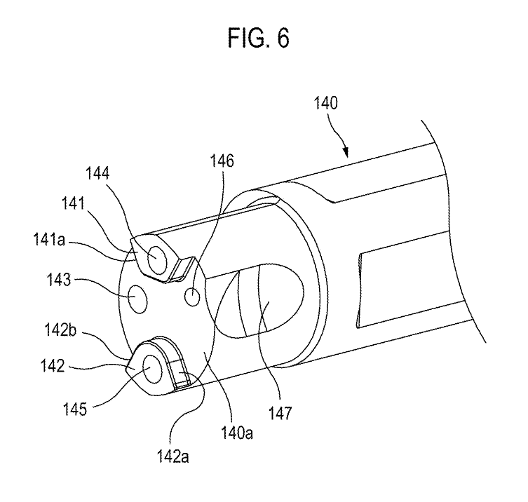

FIG. 7 is a front view of the insert holder showing relative positions between through holes and threaded holes.

FIG. 8 is a cross-sectional view taken along the line VIII-VIII of FIG. 2.

FIG. 9 is a rear view of an insert holder having a protrusion portion.

FIG. 10 is a perspective view showing a front end portion of a tool shank having a recess.

### DETAILED DESCRIPTION

A detailed description may be provided with reference to the accompanying drawings. One of ordinary skill in the art may realize that the following description is illustrative only and is not in any way limiting. Other embodiments may readily suggest themselves to such skilled persons having the benefit of this disclosure.

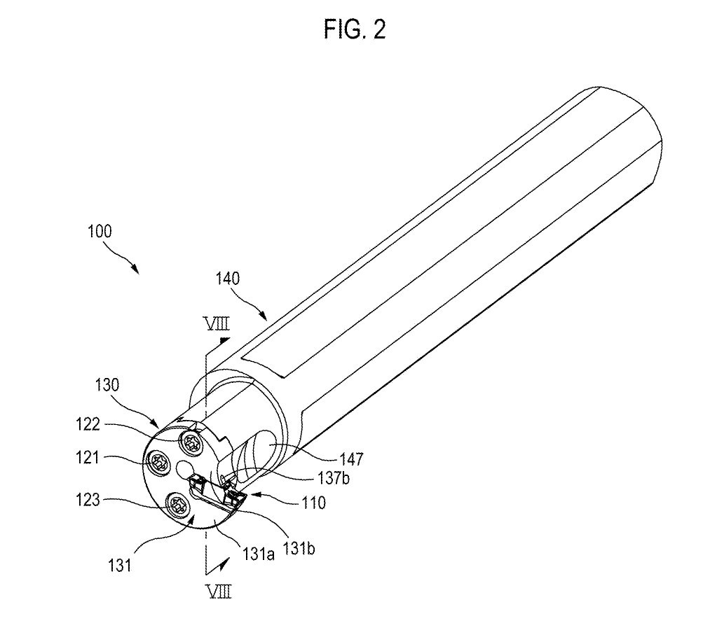

Referring to FIG. 2, a cutting tool assembly 100 according to an embodiment includes a cutting insert 110, clamping screws 121, 122 and 123, an insert holder 130 and a tool shank 140. The cutting insert 110 is retained by the insert holder 130 and the insert holder 130 is secured to the tool shank by the clamping screws 121, 122 and 123. The cutting tool assembly 100 according to an embodiment may be applied to either a cutting operation wherein the cutting tool assembly 100 rotates and a workpiece is fixed or a cutting operation wherein the cutting tool assembly 100 is fixed and a workpiece rotates. As used herein, the directional term “front,” “frontward” or the like generally refers to a direction directed from the tool shank 140 toward the insert holder 130, whereas the directional term “rear,” “rearward” or the like generally refers to a direction directed from the insert holder 130 toward the tool shank 140.

By way of example, various types of conventional cutting inserts for an internal turning operation, a threading operation, a grooving operation, etc. may be used as the cutting insert 110. The cutting insert 110 is mounted to the insert holder 130 such that its cutting edge projects radially outwardly from the insert holder 130 and the tool shank 140.

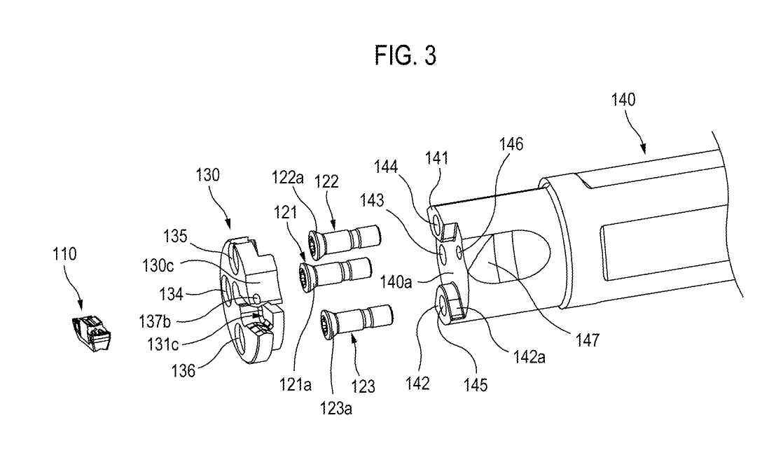

A plurality of the clamping screws 121, 122 and 123 is employed to clamp the insert holder 130 to the tool shank 140. The number of the clamping screws may be determined depending on the number of through holes provided in the insert holder 130 as well as the number of threaded holes provided in the tool shank 140. In this embodiment, said clamping screws comprise a first clamping screw 121, a second clamping screw 122 and a third clamping screw 123. The first to third clamping screws 121, 122 and 123 have the same configuration and size. In some embodiment, the first to third clamping screws 121, 122 and 123 may have different configurations and sizes. The clamping screws 121, 122 and 123 have head portions 121a, 122a and 123a, respectively. As shown in FIG. 3, the head portions 121a, 122a and 123a have a conical shape wherein its diameter decreases rearward.

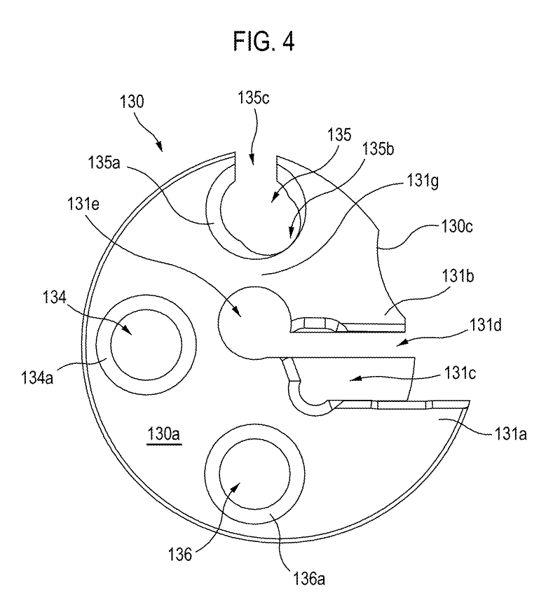

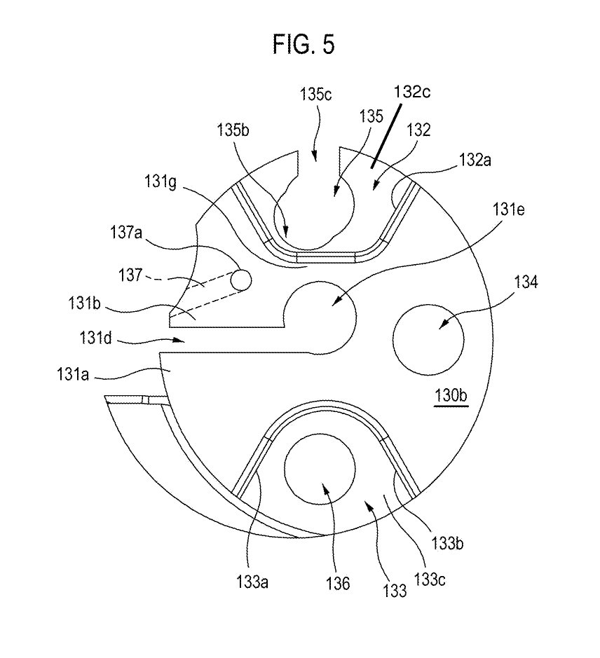

The insert holder 130 is removably mounted to the tool shank 140 by the clamping screws 121, 122 and 123. The insert holder 130 comprises a generally circular or oval plate-like body. As shown in FIGS. 4 and 5, the insert holder 130 has a front surface 130a and a rear surface 130b. The front surface 130a constitutes a front end of the cutting tool assembly 100. The rear surface 130b is coupled to the tool shank 140.

The insert holder 130 includes an insert retaining portion 131 configured to retain the cutting insert 110. Referring to FIGS. 3 to 5, the insert retaining portion 131 includes a base jaw 131a, a clamping jaw 131b, an insert pocket 131c and a slot 131d, which are defined between the base jaw 131a and the clamping jaw 131b. The slot 131d extends radially outwardly from a center of the insert holder 130. An inner end of the slot 131d, i.e., the center of the insert holder 130, is formed with a circular cutout 131e, which communicates with the slot 131d. The base jaw 131a and the clamping jaw 131b are divided by the slot 131d and the clamping jaw 131b is flexible relative to the base jaw 131a. The insert pocket 131c is recessed rearward from the front of the slot 131d. The insert pocket 131c may be variously shaped and sized to receive various types of cutting inserts 110. The cutting insert 110 is situated in the insert pocket 131c such that its longitudinal direction is parallel to the radial direction of the insert holder 130, i.e., along the orientation of the slot 131d. When the cutting insert 110 is received by the slot 131d, the base jaw 131a supports the cutting insert 110 and the clamping jaw 131b presses the cutting insert 110 against the base jaw 131a. To stably support the cutting insert 110, the base jaw 131a may have a radius greater than that of the clamping jaw 131b or a projection length greater than that of the clamping jaw 131b.

The insert holder 130 includes first and second recesses 132 and 133 at its rear surface 130b. The first and second recesses 132 and 133 are opposed to each other with respect to the orientation of the slot 131d. The first and second recesses 132 and 133 are recessed inwardly from a peripheral edge of the insert holder 130 and the rear surface 130b. The first and second recesses 132 and 133 have a wedge shape or sector shape in a planar shape. The first recess 132 has a first abutment portion 132a that interconnects a bottom surface 132c of the first recess 132 and the rear surface 130b of the insert holder 130. A lower wall of the first recess 132 is generally flat. The second recess 133 has a second abutment portion 133a and a third abutment portion 133b that interconnect a bottom surface 133c of the second recess 133 and the rear surface 130b of the insert holder 130. An upper wall of the second recess 133 is rounded. The first to third abutment portions 132a, 133a and 133b may be inclined with respect to the rear surface 130b of the insert holder 130.

The insert holder 130 includes a plurality of through holes that pass through the front surface 130a and the rear surface 130b. Said through holes comprise a first through hole 134, a second through hole 135 and a third through hole 136. The first through hole 134 is located opposite to the cutting insert 110 along the orientation of the slot 131d. The second through hole 135 is located in the first recess 132 and the third through hole 136 is located in the second recess 133. The second and third through holes 135 and 136 are adjacent to the peripheral edge of the insert holder 130 and are opposed to each other with respect to the orientation of the slot 131d. The first to third through holes 134, 135 and 136 have tapered portions 134a, 135a and 136a in its circumferential direction, respectively. The tapered portions 134a, 135a and 136a correspond to the conical head portions 121a, 122a and 123a of the clamping screws 121, 122 and 123. Further, the insert holder 130 has a cutout or slit 135c between its peripheral edge and the second through hole 135. The slit 135c is formed by removing a portion between the peripheral edge of the insert holder 130 and the second through hole 135. Moreover, the second through hole 135 has a cutout 135b at its lower side. The cutout 135b has a generally semi-cylindrical shape and is concave from a center of the second through hole 135 toward the clamping jaw 131b and the slot 131d. Thus, a flexible portion 131g is defined between the cutout 131e centrally located in the insert holder 130 and the cutout 135b of the second through hole 135. The clamping jaw 131b is flexible or deformable with respect to the base jaw 131a through the flexible portion 131g.

The insert holder 130 has a coolant duct 137. The coolant duct 137 is a passage way to which a cooling fluid for cooling the cutting insert 110 during a cutting operation on a workpiece is supplied from the tool shank 140. The coolant duct 137 has an inlet 137a (see FIG. 5), which corresponds to an outlet provided in the tool shank 140, and an outlet 137b (see FIG. 3) located in a concave surface 130c of the peripheral edge of the insert holder 130 and faces the cutting edge of the cutting insert 110. The coolant duct 137 is bent in a generally L-shape.

The tool shank 140 has an elongated cylindrical shape. The insert holder 130 is coupled to the front end surface 140a of the tool shank 140. The tool shank 140 includes first and second flanges 141 and 142 that protrude frontward from the front end surface 140a and are opposed to each other. Outer peripheral surfaces of the first and second flanges 141 and 142 and a peripheral surface of the tool shank 140 form the same surface. The first and second flanges 141 and 142 have a planar shape corresponding to the planar shape of the first and second recesses 132 and 133, e.g., a wedge shape or sector shape in a planar shape. The first and second flanges 141 and 142 correspond to the positions of the first and second recesses 132 and 133, respectively.

The first and second flanges 141 and 142 engage the first and second recesses 132 and 133, respectively. That is, when the insert holder 130 is mounted to the front end surface 140a of the tool shank 140, the first and second flanges 141 and 142 are fitted to the first and second recesses 132 and 133, respectively. The first flange 141 has a first counter abutment portion 141a that interconnects its front end surface 141c and the front end surface 140a of the tool shank 140. The second flange 142 has second and third counter abutment portions 142a and 142b that interconnect its front end surface 142c and the front end surface 140a of the tool shank 140.

The tool shank 140 includes a plurality of threaded holes, which correspond to the through holes 134, 135 and 136 provided in the insert holder 130, respectively, and which the clamping screws 121, 122 and 123 screw-engages, respectively. Said threaded holes of the tool shank 140 comprise a first threaded hole 143, a second threaded hole 144 and a third threaded hole 145. The first threaded hole 143 is formed in the front end surface 140a of the tool shank 140 and corresponds to the position of the first through hole 134. The second threaded hole 144 is located in the first flange 141 and the third threaded hole 145 is located in the second flange 142.

The tool shank 140 has a longitudinally-extending coolant duct (not shown) therein. An outlet 146 of the coolant duct of the tool shank 140 is formed in the front end surface 140a and communicates with the inlet 137a of the coolant duct 137 provided in the insert holder 130. Further, the tool shank 140 has a chip flute 147 for smooth discharge of chips. The chip flute 147 extends rearward from the front end surface 140a of the tool shank 140 and is located adjacent to the concave surface 130c of the peripheral edge of the cutting insert 110.

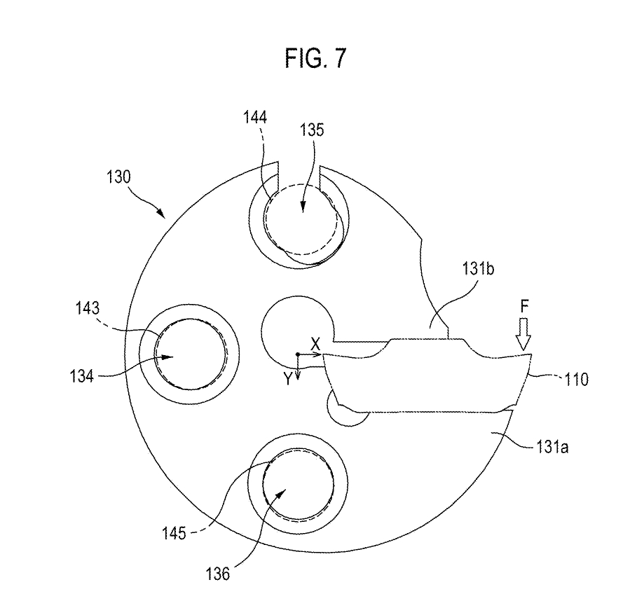

FIG. 7 shows a relative position between the through holes of the insert holder 130 and the threaded holes of the tool shank 140 when the insert holder 130 is mounted to the tool shank 140. An arrow shown in FIG. 7 represents a primary cutting force F that is applied to the cutting insert 110 during a cutting operation on a workpiece. Referring to FIG. 7, the first and third through holes 134, 135 and 136 of the insert holder 130 are offset or shifted relative to the first to third threaded holes 143, 144 and 145 of the tool shank 140, respectively. The first through hole 134 is offset from the first threaded hole 143 in a direction away from the cutting insert 110 along the orientation of the slot 131d. A first offset direction, in which the first through hole 134 is offset from the first threaded hole 143, is a direction away from the center of the insert holder 130 (in FIG. 7, a direction opposite to an X-axis direction). The second through hole 135 is offset from the second threaded hole 144 in the direction away from the cutting insert 110 parallel to the orientation of the slot 131d. A second offset direction, in which the second through hole 135 is offset from the second threaded hole 144, is parallel to the orientation of the slot 131d (in FIG. 7, a direction parallel to the direction opposite to the X-axis direction). The third through hole 136 is offset from the third threaded hole 145 along a direction opposite to the direction of the primary cutting force F. A third offset direction, in which the third through hole 136 is offset from the third threaded hole 145, is a direction toward the center of the insert holder 130 (in FIG. 7, a direction opposite to a Y-axis direction).

As the first clamping screw 121 is tightened to the first threaded hole 143 through the first through hole 134 and the head portion 121a of the first clamping screw 121 comes into surface contact with the tapered portion 134a of the first through hole 134, the insert holder 130 is pressed in a direction opposite to the first offset direction (in FIG. 7, the X-axis direction) by the tightening force from the first clamping screw 121. Thus, the first abutment portion 132a and the third abutment portion 133b press the first counter abutment portion 141a and the third counter abutment portion 142b, respectively, thereby intensifying the engagement between the first recess 132 and the first flange 141 as well as the engagement between the second recess 133 and the second flange 142. Thus, the clamping between the insert holder 130 and the tool shank 140 can be intensified.

As the second clamping screw 122 is tightened to the second threaded hole 144 through the second through hole 135 and the head portion 122a of the second clamping screw 122 comes into surface contact with the tapered portion 135a of the second through hole 135, the clamping jaw 131b is elastically pressed or biased in an oblique direction between a direction opposite to the second offset direction and a direction opposite to the third offset direction (in FIG. 7, an oblique direction between the X-axis direction and the Y-axis direction) by the tightening force from the second clamping screw 122. Thus, the clamping jaw 131b presses the cutting insert 110 against the base jaw 131a, thereby intensifying the clamping force between the insert holder 130 and the cutting insert 110.

As the third clamping screw 123 is tightened to the third threaded hole 145 through the third through hole 136 and the head portion 123a of the third clamping screw 123 comes into surface contact with the tapered portion 136a of the third through hole 136, the insert holder 130 is pressed in a direction opposite to the third offset direction (in FIG. 7, the Y-axis direction) by the tightening force from the third clamping screw 123. Thus, the second and third abutment portions 133a and 133b elastically press the second and third counter abutment portions 142a and 142b, respectively, thereby intensifying the engagement between the second recess 133 and the second flange 142, and further intensifying the clamping between the insert holder 130 and the tool shank 140.

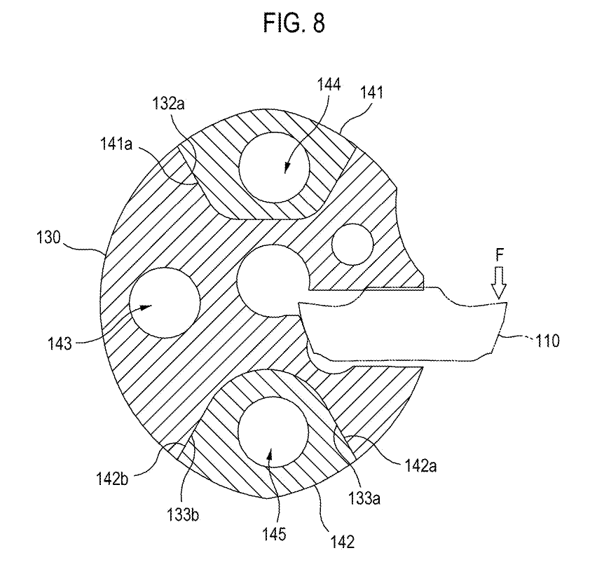

FIG. 8 shows a section taken along the line VIII-VIII of FIG. 2, wherein the first to third clamping screws 121, 122 and 123 are omitted. Referring to FIG. 8, where a cutting operation is performed, a compressive stress caused by the primary cutting force F is applied to the second abutment portion 133a, while a moment caused by the primary cutting force F is applied to the first abutment portion 132a. The second counter abutment portion 142a supports the second abutment portion 133a, to which the compressive stress caused by the primary cutting force F is applied, against said compressive stress. The first counter abutment portion 141a supports the first abutment portion 132a, to which the moment caused by the primary cutting force F is applied, against said moment. Where the cutting operation stops or the cutting operation is intermittently performed, a reaction force reacting to the primary cutting force F is applied to the third abutment portion 133b. The third counter abutment portion 142b supports the third abutment portion 133b, to which the reaction force reacting to the primary cutting force F is applied, against said reaction force. As such, the insert holder 130 is firmly clamped to the tool shank 140 throughout the entire cutting operation through the contact between the first to third abutment portions 132a, 133a and 133b and the first to third counter abutment portions 141a, 142a and 142b. Accordingly, the cutting tool assembly 100 has an enhanced service life and the workpiece cut by the cutting tool assembly 100 has an improved surface roughness.

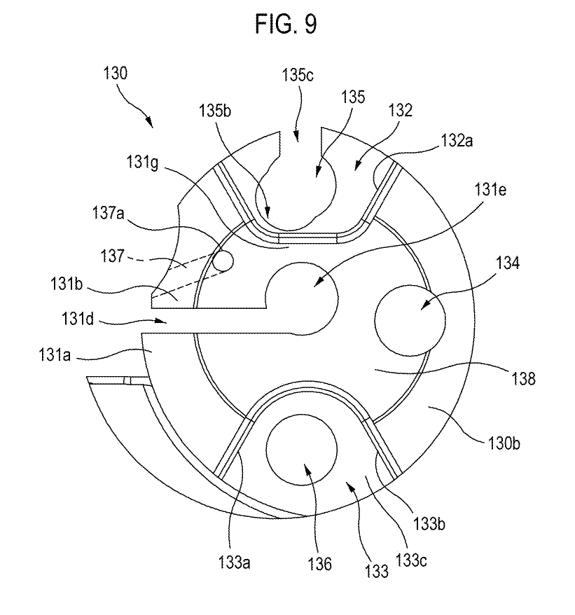

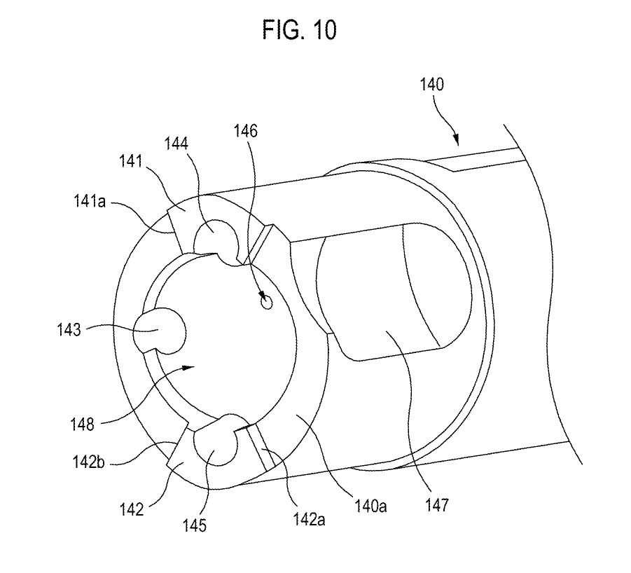

Referring to FIG. 9, the insert holder 130 includes a protrusion portion 138, which is centrally located in the rear surface 130b and protrudes rearward. The protrusion portion 138 has a cylindrical shape or a truncated conical shape. The first and second recesses 132 and 133 overlap the protrusion portion 138 in part. The protrusion portion 138 determines a position of the insert holder 130 relative to the tool shank 140 when the insert holder 130 is mounted to the tool shank 140. In case where the protrusion portion 138 has a truncated conical shape, it may guide the positioning of the insert holder 130 relative to the tool shank 140. Further, referring to FIG. 10, the tool shank 140 includes a recess 148 that corresponds to the protrusion portion 138 of the insert holder 130 and is configured to receive the protrusion portion 138. The recess 148 is centrally located in the front end surface 140a. The recess 148 has a shape and size corresponding to the shape and size of the protrusion portion 138.

According to the foregoing embodiments, the cutting tool assembly 100 includes the tool shank 140 having the threaded holes 143, 144 and 145 and the insert holder 130 having the through holes 134, 135 and 136, which are offset or shifted from the threaded holes 143, 144 and 145, respectively. Thus, as the clamping screws 121, 122 and 123 are tightened to the threaded holes 143, 144 and 145 through the through holes 134, 135 and 136, the insert holder 130 elastically contacts the tool shank 140, thus increasing the clamping force between the insert holder 130 and the tool shank 140. The offset directions of the through holes 134, 135 and 136 relative to the threaded holes 143, 144 and 145 are different from one another, thus further increasing the clamping force between the insert holder 130 and the tool shank 140.

Further, according to the foregoing embodiments, the insert holder 130 has the wedge-shaped recesses 132 and 133 and the tool shank 140 has the wedge-shaped flange 141 and 142. The moment, which is caused by the principal cutting force F acting on the cutting insert 110, can be dispersed to the abutment portions 132a, 133a and 133b of the wedge-shaped recesses 132 and 133 and the counter abutment portions 141a, 142a and 142b of the wedge-shaped flanges 141 and 142. Thus, although the principal cutting force F is applied to the cutting insert 110 throughout the entire cutting operation, the recesses 132 and 133 and the flanges 141 and 142 can maintain the contact therebetween and the tool shank 140 can stably support the insert holder 130.

Although embodiments have been described with reference to a number of illustrative embodiments thereof, it should be understood that various other modifications and embodiments can be devised by those skilled in the art that will fall within the spirit and scope of the principles of this disclosure. More particularly, numerous variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A cutting tool assembly, comprising:
a plurality of clamping screws;
an insert holder comprising:
a slot extending radially outward;
a plurality of through holes through which the plurality of clamping screws pass; and
first and second recesses located at an edge of a rear surface of the insert holder and opposed to each other with respect to an orientation of the slot;
a tool shank comprising:
a plurality of threaded holes which the plurality of clamping screws engage; and
first and second flanges opposed to each other and engaging the first and second recesses, respectively; and
a cutting insert mounted to the slot,
wherein the insert holder is removably mounted to the tool shank by the plurality of clamping screws, and
wherein the plurality of through holes is offset from the plurality of threaded holes when the insert holder is mounted to the tool shank.

2. The cutting tool assembly of claim 1, wherein the plurality of through holes comprises:
a first through hole located opposite to the cutting insert along the orientation of the slot;
a second through hole located in the first recess; and
a third through hole located in the second recess, and
wherein the plurality of threaded holes comprises:
a first threaded hole corresponding a position of the first through hole;
a second threaded hole located in the first flange; and
a third threaded hole located in the second flange.

3. The cutting tool assembly of claim 2, wherein the first through hole is offset from the first threaded hole in a direction away from a center of the insert holder along the orientation of the slot.

4. The cutting tool assembly of claim 2, wherein the second through hole is offset from the second threaded hole in a direction away from the cutting insert parallel to the orientation of the slot.

5. The cutting tool assembly of claim 2, wherein the third through hole is offset from the third threaded hole in a direction toward a center of the insert holder.

6. The cutting tool assembly of claim 2, wherein one of the second and third through holes has a slit formed by removing a portion of the insert holder.

7. The cutting tool assembly of claim 2, wherein one of the second and third through holes has a cutout concave toward the slot.

8. The cutting tool assembly of claim 1, wherein the first recess comprises a first abutment portion interconnecting the rear surface of the insert holder and a bottom of the first recess,
wherein the first flange comprises a first counter abutment portion interconnecting a front end surface of the tool shank and a front end surface of the first flange, and
wherein the first abutment portion abuts the first counter abutment portion when the insert holder is mounted to the tool shank.

9. The cutting tool assembly of claim 1, wherein the second recess comprises second and third abutment portions interconnecting the rear surface of the insert holder and a bottom of the second recess,
wherein the second flange comprises second and third counter abutment portions interconnecting a front end surface of the tool shank and a front end surface of the second flange, and
wherein the second and third abutment portions abut the second and third counter abutment portions, respectively, when the insert holder is mounted to the tool shank.

10. The cutting tool assembly of claim 1, wherein the insert holder has a protrusion portion centrally located in the rear surface and the tool shank has a recess receiving the protrusion portion of the insert holder.

11. The cutting tool assembly of claim 1, wherein the first and second recesses and the first and second flanges have a wedge shape or sector shape in a planar shape.
